(19) United States
(12) Patent Application Publication
(10) Pub. No.: US 2008/0129174 A1
(43) Pub. Date: Jun. 5, 2008

(54) Nir Incandescent Lamp

(76) Inventor: Reinhard Schafer, Heidenheim (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/883,262

(22) PCT Filed: Feb. 2, 2006
(86) PCT No.: PCT/DE06/00159

§ 371 Date: Aug. 3, 2007

(30) Foreign Application Priority Data
Feb. 7, 2005 (DE) 10 2005 005 754.3

(51) Int. Cl. H01K 1/28

(52) U.S. Cl. 313/112

(57) ABSTRACT

The invention relates to an incandescent lamp, in particular, a halogen incandescent lamp for the generation of light in a near-infra-red wavelength range (NIR-wavelength range), comprising a transparent lamp housing, an illuminant enclosed by the lamp housing and an interference filter arranged on the lamp housing, comprising several layer stacks (30, 32, 34) with a number of optically low-refraction and high-refraction layers, whereby a first layer stack (30) of the interference filter (28) is embodied as an absorption filter for the absorption of unwanted light spectra, comprising at least two absorption layers and an optical low-refraction intermediate layer, arranged between the absorption layers. According to the invention, the absorption filter (30) has a low transmission of light in an essentially red spectral range and the interference filter (28) has a filter edge in the NTR wavelength range as a result of the further layer stack (32, 34).

### TECHNICAL FIELD

The invention relates to an incandescent lamp in accordance with the precharacterizing clause of patent claim 1.

### PRIOR ART

Such incandescent lamps are used, for example, in the field of automotive engineering as an NIR (near-infrared) light source of active night vision devices.

In such night vision devices which are arranged, for example, on vehicles, an NIR headlamp fitted to the front of the vehicle emits near-infrared radiation which is reflected by objects on the roadway or at the edge of the roadway and is recorded by a digital camera equipped with CCD or CMOS sensors. The image received by the camera is represented on a flat screen in the vehicle—interior or projected by means of a head-up display in the field of vision of the driver against the windshield. Owing to the use of active night vision devices, objects are visible to the vehicle driver before they can be identified by conventional automobile headlamps. In order that the NIR headlamp is not mistaken by oncoming traffic as being tail lights or brake lights, it is necessary to completely suppress all of the light in the visible wavelength range by an optical filter system. The transition region from the suppressed visible wavelength range (VIS range) to the photogenic NIR wavelength range in this case needs to be very narrow owing to a steep filter edge. The steep filter edge on the one hand prevents the transition region from being in the VIS wavelength range and undesirable red residual light from being emitted and on the other hand prevents the transition region from running too far into the NIR range and the radiation intensity from being decreased in this range.

The German laid-open specification DE 100 23 936 A1 has disclosed an incandescent lamp for producing light in the visible red color spectrum, whose lamp vessel has a heat-resistant oxidic interference filter coating comprising five layer stacks. The first layer stack of the interference filter forms an absorption layer having two integrated thin absorber layers for absorbing undesired blue and violet light spectra. The interference coating applied in the subsequent four layer stacks comprises layers having a low optical refractive index and layers having a high optical refractive index and serves the purpose of further suppressing light from the violet and blue spectral range and of setting the filter edge of the interference filter in the visible red spectral range. Such incandescent lamps, owing to their steep filter edge, produce visible red light at a wavelength of approximately 590 nm. In order to move the filter edge into the NIR wavelength range, relatively thick layers need to be used for the interference filter which, however, bring about transmissivity in the short-wave VIS range, and, as a result, residual light which is undesirable for NIR applications is emitted.

### DESCRIPTION OF THE INVENTION

The invention is based on the object of providing an incandescent lamp which, in comparison with conventional solutions, enables improved suppression of visible light with at the same time maximum transmissivity in the NIR wavelength range.

This object is achieved according to the invention by the features of claim 1. Particularly advantageous embodiments of the invention are described in the dependent claims.

The incandescent lamp according to the invention for producing electromagnetic radiation in a near-infrared wavelength range (NIR wavelength range) has a transparent lamp vessel, which surrounds a luminous means, and an interference filter, which is arranged on the lamp vessel and has a plurality of layer stacks with a large number of layers having a low optical refractive index and layers having a high optical refractive index. A first layer stack of the interference filter is in the form of an absorption filter for absorbing undesirable light spectra with at least two absorption layers and one intermediate layer having a low optical refractive index arranged between the absorption layers. According to the invention, the absorption filter has a low transmission for light in a substantially red spectral range, the interference filter, owing to the further layer stacks, having a filter edge in the NIR wavelength range. Owing to the low transmission of the absorption filter in the red spectral range, in comparison with the prior art fewer layer stacks are required since the layer thicknesses of the following layer stacks can be optimized for a steep filter edge and a high transmission for light from the NIR spectral range. As a result, electromagnetic radiation is emitted in the desired NIR range and the emission of undesired red residual light is largely prevented.

Preferably, the layer thicknesses of the absorption layers and of the intermediate layer having a low optical refractive index are designed such that they have a low transmission for light from the red spectral range and a high transmission for electromagnetic radiation from the NIR wavelength range. In particular, the absorption filter has a transmission of less than or equal to 50% in the wavelength range of from 590 nm to 700 nm. The filter edge of the interference filter according to the invention, as a result of the abovementioned explanations, is preferably designed to be steep such that the transition of the transmission from 10% to 80% takes place in a wavelength range of less than or equal to 50 nm.

In accordance with a preferred exemplary embodiment, the two absorption layers consist of iron oxide Fe₂O₃. The Fe₂O₃ layers have metallic properties in the violet to red spectral range and dielectric properties in the NIR wavelength range, given a sufficient layer thickness. By matching and optimizing the layer thicknesses of the Fe₂O₃ layers, in combination with the intermediate layer having a low optical refractive index, a high transmission in the NIR wavelength range and a high absorption for light in the visible violet to red spectral range is achieved.

In a preferred exemplary embodiment, the layer thickness of a first absorption layer, which is arranged directly on the lamp vessel, has a layer thickness ratio in the range of from approximately 1:3 to 1:9 in relation to the layer thickness of a second absorption layer, which follows the intermediate layer having a low optical refractive index.

The first absorption layer preferably has a layer thickness in the range of from approximately 20 nm to 40 nm and/or the second absorption layer has a layer thickness in the range of from approximately 180 nm to 210 nm.

The interference filter is preferably optimized such that the filter edge is in the NIR wavelength range, in particular in a wavelength range of from approximately 760 nm to 1000 nm, preferably in the range of from 780 nm to 790 nm. This ensures that the incandescent lamp according to the invention emits a light spectrum in the NIR wavelength range and that the emission of undesired red residual light is prevented.

In a preferred embodiment of the invention, the layers having a low optical refractive index are SiO₂ layers, and the layers having a high optical refractive index are Nb₂O₅ layers. However, other materials conventional in thin-film technology can also be used such as TiO₂, Ta₂O₅, ZrO₂, HfO₂, for example, or metal nitrides. The interference filter coating can take place by means of coating processes known from the general prior art, for example by means of a sputtering or CVD process.

The layers having a low optical refractive index substantially have a layer thickness in the range of from approximately 100 nm to 130 nm, and the layers having a high optical refractive index substantially have a layer thickness in the range of from approximately 30 nm to 80 nm and are arranged alternately on the lamp vessel.

It has been proven to be particularly advantageous to form the interference filter from at least three layer stacks and/or 36 layers.

The second layer stack of the interference filter is preferably begun by a layer having a high optical refractive index with a layer thickness of from approximately 10 nm to 20 nm and/or the third layer stack of the interference filter is terminated by a layer having a high optical refractive index with a layer thickness of from approximately 25 nm to 45 nm.

The incandescent lamp according to the invention is preferably used as an infrared radiator in night vision devices, in particular in an NIR vehicle headlamp. However, it may also be used as an infrared radiator for heating purposes.

### BRIEF DESCRIPTION OF THE DRAWINGS

The invention will be explained in more detail below with reference to a preferred exemplary embodiment. In the drawings:

FIG. 1 shows a side view of an incandescent lamp in accordance with the preferred exemplary embodiment of the invention,

FIG. 2 shows transmission curves of the three layer stacks of the interference filter and of the interference filter in accordance with the prior art, and FIG. 3 shows the transmission curve of the interference filter according to the invention.

### PREFERRED EMBODIMENT OF THE INVENTION

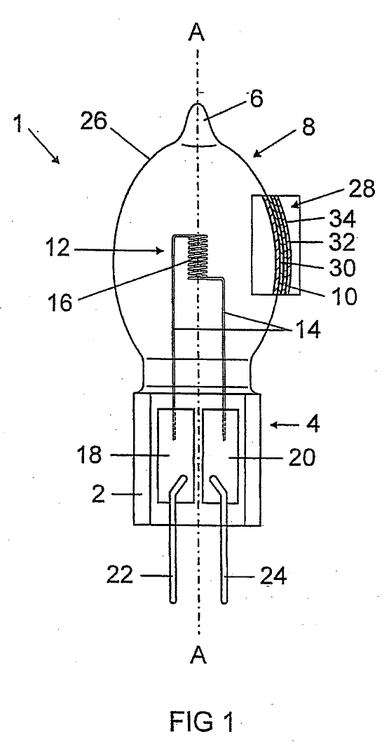

FIG. 1 shows an incandescent lamp 1 for producing light in an NIR wavelength range, which is used, for example, as a light source for an active night vision device in an NIR vehicle headlamp. This incandescent lamp 1 has a lamp base 4 in the form of a pinch seal 2 and a lamp vessel 8, which is rotationally symmetrical about a lamp axis A-A, is sealed via an exhaust tube 6, consists of lamp glass 10 and surrounds a luminous means 12. The luminous means 12 is an incandescent filament 16, which is aligned axially in the lamp vessel 8 and whose outgoing filament sections 14 are each welded to a molybdenum foil 18, 20 embedded in the pinch seal 2 of the lamp vessel 8. The molybdenum foils 18, 20 are each connected to a power supply wire 22, 24 protruding out of the pinch seal 2. Substantially the entire outer surface 26 of the lamp vessel 8 is coated with an interference filter 28, which, according to the invention, has a high transmission for electromagnetic radiation in the NIR wavelength range and is virtually untransmissive for electromagnetic radiation of other spectral ranges.

As shown in table 1, the interference filter 28 comprises in total 36 interference and absorption layers, which, in contrast to the prior art, are not arranged in five layer stacks but in three layer stacks 30, 32, 34, beginning with layer No. 1 on the outer surface 26 of the lamp vessel 8.

The layer structure of the interference filter 28 comprises layers having a low optical refractive index and layers having a high optical refractive index which are applied alternately to the lamp vessel 8 using the sputtering technique. The first layer stack 30 of the interference filter 28 is in the form of an absorption filter and is applied directly to the lamp vessel 8. The absorption filter comprises a first absorption layer consisting of Fe₂O₃ (iron oxide) having a physical layer thickness of approximately 32 nm and a second absorption layer consisting of Fe₂O₃ having a substantially larger physical layer thickness of approximately 194 nm and an intermediate layer having a low optical refractive index, which is arranged between the two absorption layers, consists of SiO₂ (silicon dioxide) and has a physical layer thickness of approximately 55 nm. The layer thickness of the first absorption layer forms a layer thickness ratio of approximately 1:6 in relation to the layer thickness of the second absorption layer, i.e. the second absorption layer is substantially thicker than the first absorption layer. Owing to its layer thickness of 194 nm, the second Fe₂O₃ absorption layer has metallic properties in the violet to red spectral range and dielectric properties in the NIR wavelength range. In combination with the SiO₂ intermediate layer having a low optical refractive index, a high transmission in the NIR wavelength range and a high absorption for light in the visible violet to red spectral range are thus achieved. Owing to the low transmission of the absorption filter in the red spectral range according to the invention, in comparison with the prior art only three instead of five layer stacks are required since the layer thicknesses of the layer stacks 32, 34 following on the first layer stack 30 are optimized for a steep filter edge and a high transmission for light from the NIR spectral range. As a result, light in the desired NIR range is emitted and the emission of undesirable red residual light is prevented.

The second layer stack 32 is formed by a layer sequence which is repeated eight times and which comprises layers having a high optical refractive index and consisting of Nb₂O₅ (niobium pentoxide) and layers having a low optical refractive index and consisting of SiO₂. This second layer stack 32 has a low transmission for light from the violet and blue spectral range and, in addition to the absorption filter formed by the first layer stack 30, serves the purpose of further suppressing green and yellow light spectra.

The third layer stack 32 is likewise formed by a layer sequence which is repeated eight times and comprises layers having a high optical refractive index and consisting of Nb₂O₅ and layers having a low optical refractive index and consisting of SiO₂ and, in addition to the suppression of red light spectra, serves the purpose of setting the filter edge of the interference filter 28 in the NIR wavelength range at approximately 790 nm. The layer thicknesses of the Nb₂O₅ and SiO₂ layers are optimized in this stack such that the interference filter 28 at a light wavelength of approximately 790 nm has a steep transition from the visible spectral range of low transmission to the NIR range of high transmission.

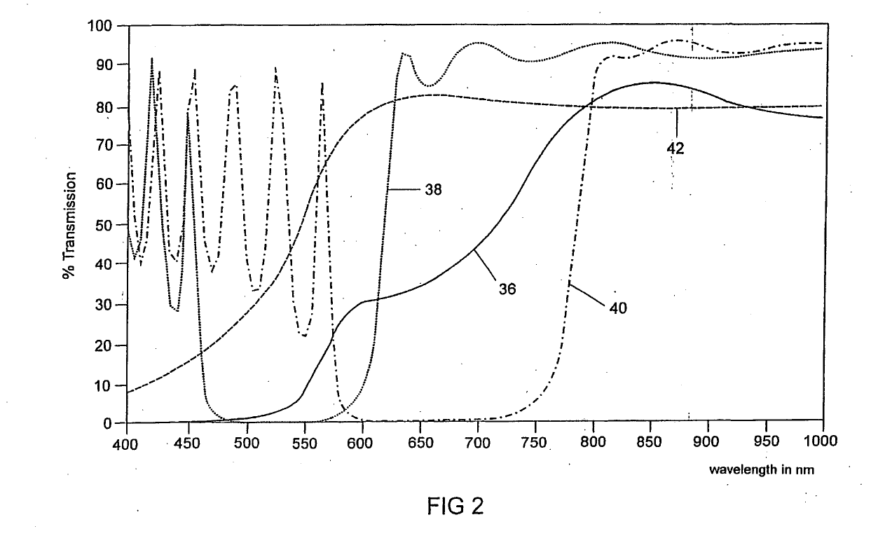

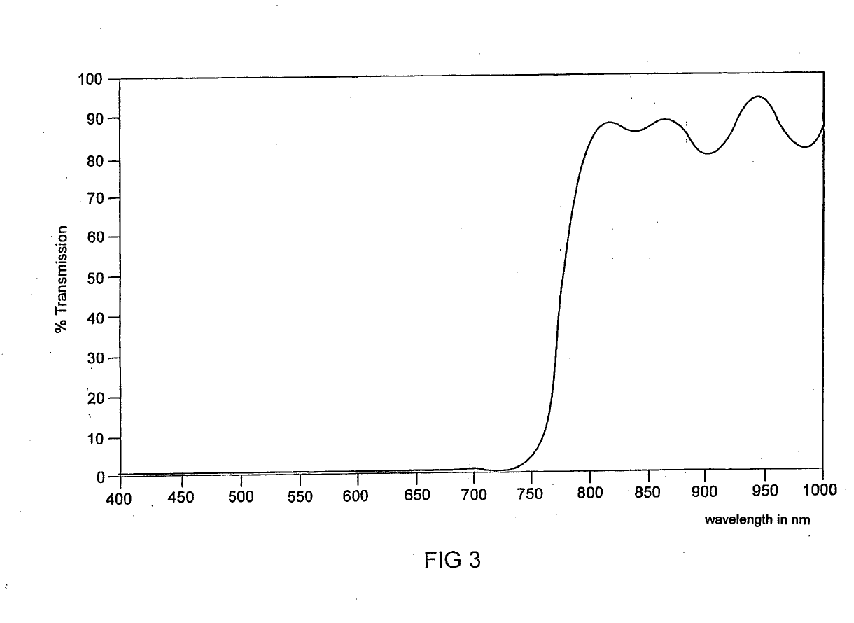

FIG. 2 illustrates the transmission behavior of the first layer stack 30, which is in the form of an absorption filter, by means of a curve 36, the transmission behavior of the second layer stack 32 by means of a curve 38 indicated by a dotted line and the transmission behavior of the third layer stack 34 by means of a curve 40 indicated by a dash-dotted line. Furthermore, the transmission behavior of the first layer stack in accordance with the prior art according to DE 100 23 936 A1 is indicated by a dashed curve 42.

As shown by the curve 36, the absorption filter of the first layer stack 30 is designed such that the short-wave violet to red spectral range (approximately <720 nm) which is undesirable for NIR applications is largely absorbed, i.e. the transmission oscillations of the curves 38 and 40 in the range of from approximately 400 nm to 580 nm are superimposed by the absorption effect of the first layer stack 30. Owing to the reduced transmission of the absorption filter in the red spectral range according to the invention in comparison with the curve 42 in accordance with the prior art, fewer layer stacks are consequently required since the layer thicknesses of the following layer stacks 32, 34 are optimized for a steep filter edge and a high transmission for electromagnetic radiation from the NIR spectral range (>780 nm). For this reason, the interference filter 28 may comprise three instead of five layer stacks. The further suppression of the transmission in the yellow-red spectral range and the formation of a steep filter edge of the interference filter 28 according to the invention in the NIR wavelength range take place by means of the second and third layer stacks 32, 34 of the interference filter 28. The filter edge of the layer stack 34, in which the transmission in accordance with the curve 40 is 50% of the incident light, is approximately 790 nm in FIG. 2. FIG. 3 illustrates the transmission curve of the complete interference filter 28 according to the invention which comprises the three layer stacks 30, 32 and 34. The filter edge of the complete interference filter 28 is between 780 nm and 790 nm. The transition of the transmission from 10% to 80% takes place in the case of the interference filter 28 in a narrow wavelength range of only 37 nm. As a result, electro-magnetic radiation is emitted in the desired NIR range, and the emission of undesired red residual light is prevented. The incandescent lamp 1 according to the invention therefore emits electromagnetic radiation in the NIR wavelength range and can be used as an infrared radiator for active night vision devices in NIR vehicle headlamps.

The invention is not restricted to the exemplary embodiment explained in more detail above; in particular other suitable materials and coating processes can be used for the interference layers. Depending on the coating process, alternatively, for example, TiO₂ (titanium dioxide) can also be used as the material having a high optical refractive index. The physical layer thicknesses of TiO₂ are then altered by a factor of approximately 0.9 owing to the different refractive index.

In addition, the invention can also be implemented with a different number of layers and layer stacks having a low optical refractive index and layers and layer stacks having a high optical refractive index.

The invention is not restricted to the exemplary embodiment explained above; in particular the invention can be applied to incandescent lamps with any desired lamp vessel geometry. In addition to the application as a radiation source for night vision devices, the invention can also be used for other applications, for example as IR heating radiators.

The preferred embodiment explained in more detail is intended for minimum visible residual light. By modifying the layer design, the residual light value and its emitted color temperature can be set in a variety of ways and with variations.

The invention discloses an incandescent lamp 1, in particular a halogen incandescent lamp, for producing electromagnetic radiation in a near-infrared wavelength range (NIR wavelength range) having a transparent lamp vessel 8, a luminous means 12 surrounded by the lamp vessel 8 and an interference filter 28, which is arranged on the lamp vessel 8 and has a plurality of layer stacks 30, 32, 34 with a large number of layers having a low optical refractive index and layers having a high optical refractive index, a first layer stack 30 of the interference filter 28 being in the form of an absorption filter 30 for absorbing undesirable light spectra with at least two absorption layers and one intermediate layer having a low optical refractive index arranged between the absorption layers. According to the invention, the absorption filter 30 has a low transmission for light in a substantially red spectral range, the interference filter 28, owing to the further layer stacks 32, 34, having a filter edge in the NIR wavelength range.

TABLE 1
Structure of the interference filter coating

| | | | Approximate |
|---|---|---|---|
| Layer stack | | | layer |
| No. | Layer No. | Type of layer | thickness [nm] |
| 30 | 1 | Fe₂O₃ | 32 |
| | 2 | SiO₂ | 55 |
| | 3 | Fe₂O₃ | 194 |
| 32 | 4 | Nb₂O₅ | 14 |
| | 5 | SiO₂ | 116 |
| | 6 | Nb₂O₅ | 40 |
| | 7 | SiO₂ | 116 |
| | 8 | Nb₂O₅ | 40 |
| | 9 | SiO₂ | 116 |
| | 10 | Nb₂O₅ | 40 |
| | 11 | SiO₂ | 116 |
| | 12 | Nb₂O₅ | 40 |
| | 13 | SiO₂ | 116 |
| | 14 | Nb₂O₅ | 40 |
| | 15 | SiO₂ | 116 |
| | 16 | Nb₂O₅ | 40 |
| | 17 | SiO₂ | 116 |
| | 18 | Nb₂O₅ | 40 |
| | 19 | SiO₂ | 116 |
| 34 | 20 | Nb₂O₅ | 62 |
| | 21 | SiO₂ | 117 |
| | 22 | Nb₂O₅ | 71 |
| | 23 | SiO₂ | 117 |
| | 24 | Nb₂O₅ | 71 |
| | 25 | SiO₂ | 117 |
| | 26 | Nb₂O₅ | 71 |
| | 27 | SiO₂ | 117 |
| | 28 | Nb₂O₅ | 71 |
| | 29 | SiO₂ | 117 |
| | 30 | Nb₂O₅ | 71 |
| | 31 | SiO₂ | 117 |
| | 32 | Nb₂O₅ | 71 |
| | 33 | SiO₂ | 117 |
| | 34 | Nb₂O₅ | 71 |
| | 35 | SiO₂ | 117 |
| | 36 | Nb₂O₅ | 36 |

1. An incandescent lamp for producing electromagnetic radiation in a near-infrared wavelength range (NIR wavelength range) having a transparent lamp vessel (8), a luminous means (12) surrounded by the lamp vessel (8) and an interference filter (28), which is arranged on the lamp vessel (8) and has a plurality of layer stacks (30, 32, 34) with a large number of layers having a low optical refractive index and layers having a high optical refractive index, a first layer stack (30) of the interference filter (28) being in the form of an absorption filter (30) for absorbing undesirable light spectra with at least two absorption layers and one intermediate layer having a low optical refractive index arranged between the absorption layers, characterized in that the absorption filter (30) has a low transmission for light in a substantially red spectral range, and the interference filter (28), owing to the further layer stacks (32, 34), has a filter edge in the NIR wavelength range.

2. The incandescent lamp as claimed in claim 1, the layer thicknesses of the absorption layers and of the intermediate layer having a low optical refractive index being optimized such that they have a low transmission for light from the red spectral range and a high transmission for light from the NIR wavelength range.

3. The incandescent lamp as claimed in claim 1 or 2, the layer thickness of a first absorption layer, which is arranged directly on the lamp vessel, having a layer thickness ratio in the range of from approximately 1:3 to 1:9 in relation to the layer thickness of a second absorption layer, which follows the intermediate layer having a low optical refractive index.

4. The incandescent lamp as claimed in claim 3, the two absorption layers being Fe₂O₃ layers.

5. The incandescent lamp as claimed in claim 4, the first absorption layer having a layer thickness in the range of from approximately 20 nm to 40 nm and/or the second absorption layer having a layer thickness in the range of from approximately 180 nm to 210 nm.

6. The incandescent lamp as claimed in claim 1, the layers having a low optical refractive index being SiO₂ layers, and the layers having a high optical refractive index being Nb₂O₅ layers.

7. The incandescent lamp as claimed in claim 1, the layers having a low optical refractive index substantially having a layer thickness in the range of from approximately 100 nm to 130 nm, and the layers having a high optical refractive index substantially having a layer thickness in the range of from approximately 30 nm to 80 nm and being arranged alternately.

8. The incandescent lamp as claimed in claim 1 or 2, the interference filter (28) comprising at least three layer stacks (30, 32, 34).

9. The incandescent lamp as claimed in claim 8, a second layer stack (32) of the interference filter (28) having a first layer having a high optical refractive index and with a layer thickness of from approximately 10 nm to 20 nm in the beam direction and/or a third layer stack (34) of the interference filter (28) having a last layer having a high optical refractive index and with a layer thickness of from approximately 25 nm to 45 nm.

10. The incandescent lamp as claimed in claim 1, the interference filter (28) having 36 layers.

11. The incandescent lamp as claimed in claim 1, the interference filter (28) being formed such that its filter edge is in a wavelength range of from 760 nm to 1000 nm.

12. The incandescent lamp as claimed in claim 1, the transmission of the absorption filter (30) for light in the wavelength range of from 590 nm to 700 nm being less than or equal to 50%.

13. The incandescent lamp as claimed in claim 1 or 11, the filter edge being designed such that the transition of the transmission from 10% to 80% takes place in a wavelength range of less than or equal to 50 nm.

14. The incandescent lamp as claimed in claim 1, the lamp (1) being used in night vision devices, in particular in an NIR vehicle headlamp.

15. The incandescent lamp as claimed in claim 1, the lamp (1) being used as an electrical infrared radiator for heating purposes.

16. The incandescent lamp as claimed in claim 1, the interference filter (28) being formed such that its filter edge is in a wavelength range of from 780 nm to 790 nm.

17. The incandescent lamp as claimed in claim 3, the first absorption layer having a layer thickness in the range of from approximately 20 nm to 40 nm and/or the second absorption layer having a layer thickness in the range of from approximately 180 nm to 210 nm.
